(19) United States
(12) Patent Application Publication
(10) Pub. No.: US 2019/0193721 A1
(43) Pub. Date: Jun. 27, 2019

(54) VEHICLE CONTROL APPARATUS AND VEHICLE CONTROL SYSTEM

(71) Applicants: TOYOTA JIDOSHA KABUSHIKI KAISHA, Toyota-shi (JP); DENSO CORPORATION, Kariya-city (JP)

(72) Inventors: Naoki YAMAMURO, Nagoya-shi (JP); Shinichi ADACHI, Kariya-shi (JP); Ryo HATTORI, Kariya-shi (JP); Taichi AMAKASU, Toyota-shi (JP); Keigo HIRUMA, Kariya-shi (JP)

(21) Appl. No.: 16/232,368

(22) Filed: Dec. 26, 2018

(30) Foreign Application Priority Data
Dec. 27, 2017 (JP) 2017-252411

(51) Int. Cl. B60W 30/02; B60W 10/04; B60W 10/22

(52) U.S. Cl. CPC B60W 30/02; B60W 10/04; B60W 10/22; G05D 1/0088; B60W 2400/00; B60W 2710/226; B60W 2720/106; B60W 2300/12

(57) ABSTRACT

The present disclosure realizes the transport quality and the transport cost corresponding to, for example, the type of a cargo transported by a vehicle. The present disclosure resides in a vehicle control apparatus for attenuating the vibration of the vehicle by adjusting a parameter that affects a predetermined acceleration so that the predetermined acceleration, which includes at least one of an acceleration in an upward-downward direction of the vehicle, an acceleration in a lateral direction of the vehicle, and an acceleration in a front-back direction of the vehicle, approaches a target acceleration, wherein a required vibration suppression level of the cargo transported by the vehicle is acquired, and the target acceleration is set on the basis of the acquired required vibration suppression level. Then, the control apparatus adjusts the parameter that affects the predetermined acceleration on the basis of the set target acceleration.

### CROSS REFERENCE TO RELATED APPLICATIONS

This application claims the benefit of Japanese Patent Application No. 2017-252411, filed on Dec. 27, 2017, which is hereby incorporated by reference herein in its entirety.

### BACKGROUND

### Technical Field

The present disclosure relates to a vehicle control apparatus for a vehicle for transporting a cargo. In particular, the present disclosure relates to a technique for attenuating the vibration of the vehicle.

### Description of the Related Art

In relation to the vehicle such as an automobile or the like, such a technique is known that the vibration of the vehicle is attenuated and thus the damping or vibration suppression performance of the vehicle is improved by adjusting the parameter which affects the predetermined acceleration including at least one of the acceleration in the upward-downward direction of the vehicle, the acceleration in the lateral direction of the vehicle, and the acceleration in the front-back direction of the vehicle, such as the damping force characteristic of a damper concerning a suspension, the roll stiffness of a stabilizer, the response characteristic of a steering, the rate of change of the vehicle speed or the like. For example, Japanese Patent Application Laid-Open No. 2010-241422 suggests an active type suspension system in which the vibration is attenuated by detecting any undesired vibration of a wheel and/or a vehicle body which may be generated by the variation of the spring stiffness of an air suspension, and adjusting the damping force characteristic of the air suspension depending on the detected vibration.

### SUMMARY

In recent years, the types of cargoes, which are dealt with by the cargo transport vehicle, are progressively diversified on account of the widespread use of the mail order service based on the use of the internet. Therefore, it is estimated that the opportunities of the transport will be progressively increased not only for the cargoes such as clothing, food, books or the like for which the vibration of the vehicle hardly affects the quality but also for the cargoes such as precision machines, electronic equipment, glass products or the like for which the vibration of the vehicle easily affects the quality.

In this context, assuming that the cargo, for which the vibration of the vehicle easily affects the quality, is transported by the vehicle, it is desired that the predetermined acceleration described above is suppressed to be small as far as possible so that the vibration suppression performance of the vehicle is raised or enhanced thereby and thus the transport quality of the cargo is enhanced. In the meantime, if it is intended that the predetermined acceleration described above is suppressed to be small in the active type suspension system as described above, it is necessary that the vibration in which the predetermined acceleration is relatively small should be also attenuated in addition to the vibration in which the predetermined acceleration is relatively large. In association therewith, it is necessary to repeatedly execute, in a short cycle, the detecting process for detecting the predetermined acceleration and the changing process for changing the damping force characteristic on the basis of the detected predetermined acceleration. As a result, the number of times of the operation per unit time is increased for the actuator which is provided to change the damping force characteristic of the suspension. The fuel efficiency or the electricity efficiency of the vehicle is easily deteriorated. If the fuel efficiency or the electricity efficiency of the vehicle is deteriorated for the reason as described above, then the cruising distance of the vehicle is shortened, and thus it is feared that the transport cost of the cargo may be raised. On this account, when the cargo, for which the vibration of the vehicle hardly affects the quality, is transported, it is desired that the cruising distance of the vehicle is extended by improving the fuel efficiency and/or the electricity efficiency of the vehicle as far as possible, and thus the transport cost of the cargo is lowered.

The present disclosure has been made taking the various actual circumstances as described above into consideration, an object of which is to provide a technique that makes it possible to realize the transport quality and the transport cost corresponding to the type of a cargo or the like with a vehicle control apparatus for attenuating the vibration of a vehicle by adjusting a parameter which affects a predetermined acceleration including at least one of an upward-downward acceleration, a lateral acceleration, and a front-back acceleration of the vehicle.

In the present disclosure, in order to solve the problem as described above, the target acceleration is changed depending on the required vibration suppression level of the cargo transported by the vehicle with the vehicle control apparatus for attenuating the vibration of the vehicle by adjusting the parameter which affects the predetermined acceleration so that the predetermined acceleration including at least one of the acceleration in the upward-downward direction of the vehicle, the acceleration in the lateral direction of the vehicle, and the acceleration in the front-back direction of the vehicle approaches the target acceleration. The “required vibration suppression level” referred to herein is the vibration suppression level which is required when the cargo is transported. The “required vibration suppression level” is set to a higher level, for example, for a cargo for which the vibration during the transport more easily affects the quality.

In particular, the present disclosure resides in a vehicle control apparatus which is applicable to a vehicle for transporting a cargo and which attenuates vibration of the vehicle by adjusting a parameter that affects a predetermined acceleration so that the predetermined acceleration, which includes at least one of an acceleration in an upward-downward direction of the vehicle, an acceleration in a lateral direction of the vehicle, and an acceleration in a front-back direction of the vehicle when the cargo is transported by the vehicle, approaches a target acceleration. The control apparatus acquires a required vibration suppression level which is a vibration suppression level required for the cargo transported by the vehicle, and the control apparatus sets the target acceleration on the basis of the acquired required vibration suppression level. Then, the control apparatus adjusts the parameter which affects the predetermined acceleration, on the basis of the target acceleration.

The vehicle, to which the present disclosure is applied, is the vehicle for transporting the cargo. As for the cargo referred to herein, various articles are assumed, which include, for example, the cargo such as precision machines, electronic equipment, glass products and the like for which the vibration easily affects the quality thereof (hereinafter referred to as “delicate cargo”) in addition to the cargo such as clothing, food, books and the like for which the vibration hardly affects the quality thereof (hereinafter referred to as “ordinary cargo”). When the vehicle is used to transport the various cargoes as described above, the transport quality and the transport cost, which are required when the cargo is transported, differ depending on, for example, the type of the cargo as the transport object. For example, when the delicate cargo described above is transported by the vehicle, it is necessary to raise the transport quality in order to retain the quality of the delicate cargo. On the other hand, when the ordinary cargo is transported by the vehicle, it is necessary to lower the transport cost in order to mitigate the monetary burden exerted, for example, on the transport agent and the cargo owner. In this context, in the configuration in which the vibration of the vehicle is attenuated by adjusting the parameter which affects the predetermined acceleration so that the predetermined acceleration approaches the target acceleration, the vibration suppression performance of the vehicle can be enhanced when the target acceleration is set to be small as compared with when the target acceleration is set to be large. Therefore, it is possible to raise the transport quality of the cargo, while there is a possibility that the deterioration of the fuel efficiency and/or the electricity efficiency may be caused. Therefore, there is a possibility that the transport cost of the cargo may be increased. In view of the above, in the case of the vehicle control apparatus according to the present disclosure, the required vibration suppression level of the cargo transported by the vehicle is acquired, and the target acceleration is set corresponding to the acquired required vibration suppression level. Accordingly, the parameter, which affects the predetermined acceleration, is adjusted on the basis of the target acceleration adequate for the required vibration suppression level of the cargo. As a result, it is possible to realize the transport quality and the transport cost corresponding to the required vibration suppression level of the cargo.

In this context, the control apparatus according to the present disclosure may set the target acceleration so that the predetermined acceleration is suppressed to be smaller if the required vibration suppression level is high as compared with if the required vibration suppression level is low. According to the configuration as described above, when the cargo such as the delicate cargo as described above, in which the required vibration suppression level is high, is transported, the vibration suppression performance of the vehicle is enhanced by attenuating the vibration in which the predetermined acceleration is relatively small as well in addition to the vibration in which the predetermined acceleration is relatively large. Therefore, it is possible to satisfactorily retain the quality of the cargo, and thus it is possible to enhance the transport quality of the cargo. On the other hand, when the cargo such as the ordinary cargo as described above, in which the required vibration suppression level is low, is transported, the vibration in which the predetermined acceleration is relatively large is attenuated, although the vibration in which the predetermined acceleration is relatively small is not attenuated. Therefore, the deterioration of the fuel efficiency or the electricity efficiency can be suppressed to be small, while retaining the quality of the cargo. Accordingly, the decrease in the cruising distance, which is caused by the attenuation of the vibration of the vehicle, can be suppressed to be small. Therefore, it is possible to suppress the transport cost to be small.

Further, when the vehicle is used for the cargo transport, it is also assumed that a plurality of cargoes having different required vibration suppression levels are loaded on the vehicle. In such a case, the control apparatus may acquire the required vibration suppression levels for all of the cargoes loaded on the vehicle respectively. Then, the control apparatus may set the target acceleration on the basis of the highest required vibration suppression level of the required vibration suppression levels of all of the cargoes. According to the configuration as described above, when the plurality of cargoes having the different required vibration suppression levels are transported by the vehicle, the cargo such as the delicate cargo as described above, in which the vibration of the vehicle easily affects the quality, can be also transported, while suppressing the decrease in the quality of the cargo.

Note that when a plurality of cargoes are loaded on the vehicle, the delivery destinations of the cargoes are not necessarily an identical place. If the delivery destinations of the plurality of cargoes are different from each other, the respective cargoes are unloaded from the vehicle at the respective delivery destinations of the cargoes. In the transport step as described above, when the cargo, which has the highest required vibration suppression level of those of the plurality of cargoes, is unloaded from the vehicle, the vibration suppression performance, which is required for the vehicle in the transport step thereafter, is lowered. Accordingly, when the cargo, which has the highest required vibration suppression level of those of the plurality of cargoes loaded on the vehicle, is unloaded from the vehicle, the control apparatus according to the present disclosure may newly set the target acceleration on the basis of the highest required vibration suppression level of the required vibration suppression levels of all of the cargoes remaining on the vehicle. Accordingly, it is possible to lower the transport cost as far as possible, while suppressing the deterioration of the quality of the cargo.

Further, when a plurality of cargoes are loaded on the vehicle, the cargo collection places of the cargoes (places at which the cargoes are loaded on the vehicle) are not necessarily an identical place. Accordingly, when a new cargo, which is distinct from the cargoes having been already loaded on the vehicle, is loaded on the vehicle, the control apparatus according to the present disclosure may acquire a required vibration suppression level of the new cargo. Then, the control apparatus may newly set the target acceleration on the basis of the required vibration suppression level of the new cargo, if the required vibration suppression level of the new cargo is higher than the required vibration suppression levels of all of the cargoes having been already loaded on the vehicle. Accordingly, even when the cargo, which has the required vibration suppression level higher than those of the cargoes having been already loaded, is newly loaded on the vehicle during the cargo transport step, it is possible to realize the transport quality adequate for the cargo newly loaded on the vehicle.

Further, for example, the magnitude of the vibration generated in the cargo loading space of the vehicle is not necessarily uniform in the entire region of the space. On this account, when the cargo is loaded on the vehicle, it is desirable that the cargo is arranged at the position (hereinafter referred to as “low vibration position” in some cases) at which the vibration is easily decreased relatively, of the cargo loading space of the vehicle. However, if the number of cargoes is increased, and/or if the size of the cargo is increased, then there is a possibility that it may be difficult to arrange all of the cargoes at the low vibration position as described above. Then, if the cargo is arranged at the position (hereinafter referred to as “high vibration position” in some cases) which is deviated from the low vibration position described above, there is a possibility that the vibration, which acts on the cargo, may be larger than any assumed vibration. In view of the above, the control apparatus according to the present disclosure may acquire information about cargo arrangement in a cargo loading space of the vehicle, and the control apparatus may correct the target acceleration on the basis of the acquired cargo arrangement information. Then, the control apparatus may adjust the parameter which affects the predetermined acceleration on the basis of the corrected target acceleration. According to the configuration as described above, even if a situation arises such that the cargo is arranged at the high vibration position as described above, it is possible to suppress the deterioration of the quality of the cargo arranged at the high vibration position.

In the next place, the present disclosure can be also grasped as a vehicle control system configured to include a vibration control apparatus which is carried on a vehicle, and a server apparatus which is installed outside the vehicle. In this case, the vehicle control system according to the present disclosure may comprise a vibration control apparatus which is carried on a vehicle for transporting a cargo and which attenuates vibration of the vehicle by adjusting a parameter that affects a predetermined acceleration so that the predetermined acceleration, which includes at least one of an acceleration in an upward-downward direction of the vehicle, an acceleration in a lateral direction of the vehicle, and an acceleration in a front-back direction of the vehicle when the cargo is transported by the vehicle, approaches a target acceleration, and a server apparatus which is an apparatus installed outside the vehicle, which sets the target acceleration, and which transmits the set target acceleration to the vibration control apparatus. Then, the server apparatus may acquire required vibration suppression levels which are vibration suppression levels required for respective cargoes in relation to all of the cargoes transported by the vehicle respectively, set the target acceleration on the basis of the highest required vibration suppression level of the required vibration suppression levels of all of the cargoes, and transmit the set target acceleration to the vibration control apparatus of the vehicle. According to the vehicle control system configured as described above, it is possible to realize the transport quality and the transport cost adequate for the required vibration suppression level of the cargo loaded on the vehicle, in the same manner as the vehicle control apparatus described above. Further, the setting process for setting the target acceleration, which corresponds to the required vibration suppression level of the cargo, is performed by the server apparatus which is installed outside the vehicle. Accordingly, it is possible to reduce, for example, the calculation load exerted on the vibration control apparatus. Accordingly, even when the classifications of the cargoes loaded on the vehicle are diversified, it is easy to set the target accelerations adequate for the cargoes.

In this context, the vehicle control system described above is useful when the vehicle is a vehicle capable of the autonomous traveling. That is, the vehicle may further comprise an operation control apparatus which allows the vehicle to perform autonomous traveling in accordance with a predetermined operation command. Then, the server apparatus may generate the operation command on the basis of a cargo collection place and a delivery place of the cargo to be loaded on the vehicle to transmit the generated operation command to the operation control apparatus.

According to the present disclosure, it is possible to realize the transport quality and the transport cost corresponding to, for example, the type of the cargo, with the vehicle control apparatus which attenuates the vibration of the vehicle by adjusting the parameter that affects the predetermined acceleration including at least one of the upward-downward acceleration, the lateral acceleration, and the front-back acceleration of the vehicle.

Further features of the present disclosure will become apparent from the following description of exemplary embodiments with reference to the attached drawings.

### BRIEF DESCRIPTION OF DRAWINGS

FIG. 1 indicates an outline of a moving body system to which the present disclosure is applied.

FIG. 2 indicates a block diagram schematically illustrating exemplary constitutive components possessed by the moving body system according to a first embodiment of the present disclosure.

FIG. 3 exemplifies the table configuration of the vehicle information stored in a storage unit of a server apparatus.

FIG. 4 exemplifies the table configuration of the cargo information stored in the storage unit of the server apparatus.

FIG. 5 exemplifies the table configuration of the required vibration suppression level information stored in the storage unit of the server apparatus.

FIG. 6 exemplifies the table configuration of the target acceleration information stored in the storage unit of the server apparatus.

FIG. 7 indicates a flow diagram illustrating the flow of the data and the process performed between the respective constitutive components of the moving body system according to the first embodiment of the present disclosure.

FIG. 8 exemplifies the table configuration of the cargo information stored in the storage unit of the server apparatus when a plurality of cargoes are loaded on one autonomous traveling vehicle.

FIG. 9 indicates a process flow for updating the target acceleration during the process in which the plurality of cargoes are transported by one autonomous traveling vehicle.

FIG. 10 schematically indicates the cargo loading space of the autonomous traveling vehicle.

FIG. 11 indicates a block diagram schematically illustrating exemplary constitutive components possessed by a moving body system according to a modified embodiment of a second embodiment of the present disclosure.

### DESCRIPTION OF EMBODIMENTS

An explanation will be made below on the basis of the drawings about specified embodiments of the present disclosure. For example, the dimension or size, the material, the shape, and the relative arrangement of constitutive parts or components described in the embodiments of the present disclosure are not intended to limit the technical scope of the disclosure only thereto unless specifically noted.

### First Embodiment

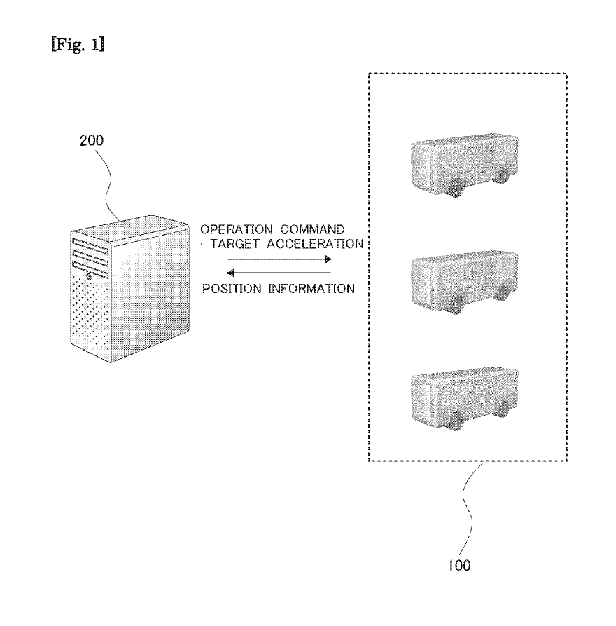

At first, a first embodiment of the present disclosure will be explained on the basis of FIGS. 1 to 7. In this section, an example will be described, in which the present disclosure is applied to vehicles as moving bodies in a moving body system including a plurality of moving bodes capable of performing the autonomous traveling.

### (System Outline)

FIG. 1 indicates an outline of a moving body system according to this embodiment. The moving body system indicaten in FIG. 1 is configured to include a plurality of autonomous traveling vehicles 100 which perform the autonomous traveling in accordance with provided operation commands, and a server apparatus 200 which issues the operation commands to the respective autonomous traveling vehicles 100. The autonomous traveling vehicle 100 is an automatic driving vehicle which provides predetermined service. On the other hand, the server apparatus 200 is an apparatus which manages the plurality of autonomous traveling vehicles 100.

Each of the autonomous traveling vehicles 100 is a multipurpose moving body in which the specification such as the inner and outer package or the like can be easily changed depending on the way of use, the vehicle being capable of performing the autonomous traveling on the road. The autonomous traveling vehicle 100 is, for example, a pickup bus which picks up (welcomes and sends off) customers along with a predetermined route, an on-demand taxi which is operated along with a route corresponding to a request from a customer, a cargo transport vehicle which transports cargoes along with a predetermined route, or a staying type passenger transport vehicle which is operated along with a route corresponding to a request from a customer (for example, a vehicle which is installed with hotel facilities or workspace in the room). When the purpose of the autonomous traveling vehicle 100 is to transport cargoes and passengers, it is possible to transport the cargoes and passengers while being operated along with a predetermined route. On the other hand, when the object (purpose) of the way of use of the autonomous traveling vehicle 100 is the staying and the transport of passengers, it is possible to transport the passengers while allowing the passengers to lodge or work in the room. Note that it is not necessarily indispensable that the autonomous traveling vehicle 100 of this embodiment should be a vehicle on which any person other than passengers does not get. For example, the customer service personnel to perform the customer service for passengers, the security personnel to secure the safety of the autonomous traveling vehicle 100, or the collection and delivery personnel to load and unload cargoes may be accompanied. Further, it is also allowable that the autonomous traveling vehicle 100 is not necessarily a vehicle which can perform the complete autonomous traveling. The autonomous traveling vehicle 100 may be a vehicle for which the driving personnel performs the driving or the assistance for the driving depending on circumstances.

Further, each of the autonomous traveling vehicles 100 also has the function such that the vibration of the autonomous traveling vehicle 100 is attenuated by adjusting the parameter which affects the predetermined acceleration so that the predetermined acceleration, which is generated during the traveling of the autonomous traveling vehicle 100, approaches the target acceleration. The “predetermined acceleration” referred to herein includes, for example, the acceleration in the upward-downward direction of the autonomous traveling vehicle 100, the acceleration in the lateral direction of the autonomous traveling vehicle 100, and the acceleration in the front-back direction of the autonomous traveling vehicle 100. That is, each of the autonomous traveling vehicles 100 adjusts the parameters which affect the accelerations in the three directions described above so that the accelerations in the three directions described above approach the target accelerations corresponding thereto respectively. Further, the parameter, which affects the predetermined acceleration as described above, is, for example, the damping force characteristic (damping coefficient or attenuation coefficient) of a damper (shock absorber) attached to the suspension of the autonomous traveling vehicle 100, the spring constant of an air spring attached to the suspension of the autonomous traveling vehicle 100, the roll stiffness of a stabilizer provided to span the left and right wheels of the autonomous traveling vehicle 100, the response characteristic of a steering (for example, the rate of change of the turning velocity of the wheel WH), the vehicle velocity, or the rate of change of the vehicle velocity. Note that in this embodiment, a case will be described, in which the damping force characteristic (damping coefficient or attenuation coefficient) of the damper included in the parameters described above is adjusted.

The server apparatus 200 is an apparatus which commands the respective autonomous traveling vehicles 100 to perform the operation. For example, when the autonomous traveling vehicle 100 is a cargo transport vehicle, the server apparatus 200 accepts a request from a user and acquires the cargo collection point (departure point) at which the cargo is loaded on the autonomous traveling vehicle 100 and the delivery point (destination point) at which the cargo is unloaded from the autonomous traveling vehicle 100. After that, the server apparatus 200 transmits the operation command to the effect that “cargo is transported from the cargo collection point to the delivery point”, to the autonomous traveling vehicle 100 which is included in the autonomous traveling vehicles 100 traveling in the neighborhood and which has the facilities or equipment adequate for the cargo transport. Accordingly, the autonomous traveling vehicle 100, which receives the operation command from the server apparatus 200, travels along the route based on the operation command, and thus it is possible to transport the cargo from the cargo collection point to the delivery point. Note that the operation command not necessarily commands the autonomous traveling vehicle 100 to perform the traveling to connect the departure point and the destination point. For example, the operation command may be “unload cargoes and passengers at a predetermined point between the departure point and the destination point” or “stop for a predetermined time at a predetermined sightseeing spot between the departure point and the destination point”. In this way, the operation command may include the action other than the traveling to be performed by the autonomous traveling vehicle 100.

Further, the server apparatus 200 has the function to change the target acceleration described above depending on the required vibration suppression level of the cargo loaded on the autonomous traveling vehicle 100 when the autonomous traveling vehicle 100 is used as the cargo transport vehicle. Note that the “required vibration suppression level” referred to herein is the vibration suppression level required during the transport of the cargo as described above, which is set, for example, to the higher level for the cargo for which the vibration during the transport more easily affects the quality. Further, as for the cargo transported by the autonomous traveling vehicle 100, various cargoes are assumed, which include, for example, the articles (delicate cargoes) such as precision machines, electronic equipment, glass products and the like for which the vibration easily affects the quality thereof, in addition to the articles (ordinary cargoes) such as clothing, food, books and the like for which the vibration hardly affects the quality thereof. Then, when the delicate cargo described above is transported by the autonomous traveling vehicle 100, the server apparatus 200 sets the target acceleration so that the predetermined acceleration of the autonomous traveling vehicle 100 is suppressed to be smaller, as compared with when the ordinary cargo described above is transported by the autonomous traveling vehicle 100. Accordingly, when the autonomous traveling vehicle 100 transports the delicate cargo, the vibration suppression performance of the autonomous traveling vehicle 100 is more enhanced or raised, as compared with when the autonomous traveling vehicle 100 transports the ordinary cargo. Therefore, it is possible to raise the transport quality of the delicate cargo, and it is possible to lower the transport cost of the ordinary cargo.

### (System Configuration)

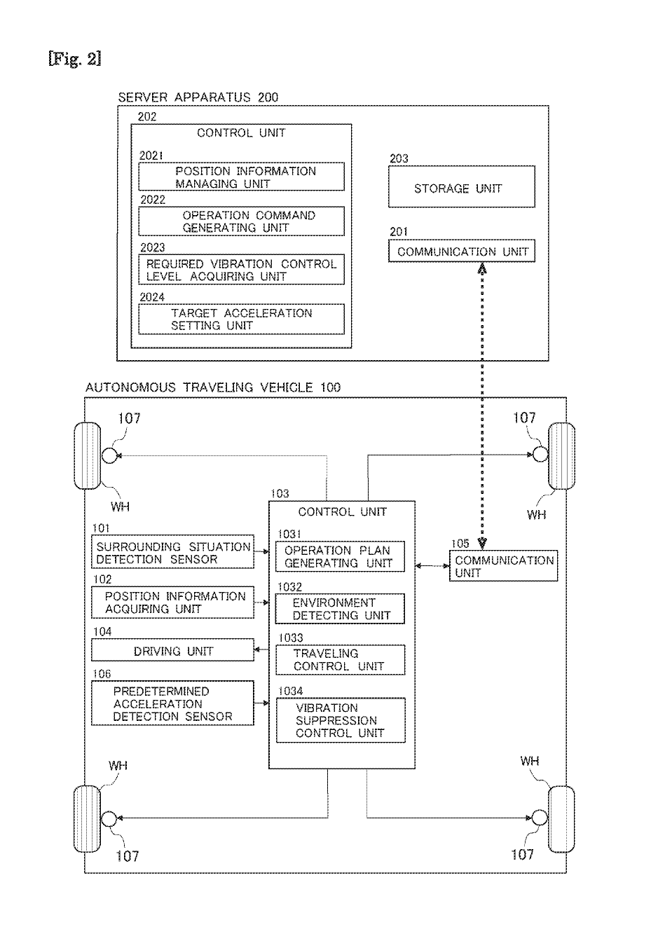

Next, an explanation will be made in detail about the constitutive components of the movement system according to this embodiment. FIG. 2 indicates a block diagram schematically illustrating exemplary configuration of the autonomous traveling vehicle 100 and the server apparatus 200 shown in FIG. 1. Note that a plurality of autonomous traveling vehicles 100 may be provided.

As described above, the autonomous traveling vehicle 100 is the vehicle which travels in accordance with the operation command acquired from the server apparatus 200. Further, the autonomous traveling vehicle 100 also has the function to adjust the damping force characteristic (damping coefficient or attenuation coefficient) during the traveling of the autonomous traveling vehicle 100 on the basis of the target acceleration acquired from the server apparatus 200. The autonomous traveling vehicle 100 as described above is configured to include, for example, a surrounding situation detection sensor 101, a position information acquiring unit 102, a control unit 103, a driving unit 104, a communication unit 105, a predetermined acceleration detection sensor 106, and damper actuators 107. Note that the autonomous traveling vehicle 100 of this embodiment is an electric automobile which is driven by using an electric motor as a motor. The motor of the autonomous traveling vehicle 100 is not limited to the electric motor, which may be an internal combustion engine or a hybrid mechanism composed of an internal combustion engine and an electric motor.

The surrounding situation detection sensor 101 performs the sensing around the vehicle. Typically, the surrounding situation detection sensor 101 is configured to include, for example, a stereo camera, a laser scanner, LIDAR, and a radar. The information, which is acquired by the surrounding situation detection sensor 101, is delivered to the control unit 103.

The position information acquiring unit 102 acquires the present position of the autonomous traveling vehicle 100. Typically, the position information acquiring unit 102 is configured to include, for example, a GPS receiver. Note that the position information acquiring unit 102 acquires the present position of the autonomous traveling vehicle 100 at a predetermined cycle and delivers it to the control unit 103. In accordance therewith, every time when the control unit 103 accepts the position information from the position information acquiring unit 102, the control unit 103 transmits the position information to the server apparatus 200. In other words, the position information of the autonomous traveling vehicle 100 is transmitted at a predetermined cycle from the autonomous traveling vehicle 100 to the server apparatus 200.

The predetermined acceleration detection sensor 106 is configured to include, for example, an upward-downward acceleration sensor for detecting the acceleration in the upward-downward direction of the autonomous traveling vehicle 100, a lateral acceleration sensor for detecting the acceleration in the lateral direction of the autonomous traveling vehicle 100, and a front-back acceleration sensor for detecting the acceleration in the front-back direction of the autonomous traveling vehicle 100. In this arrangement, the upward-downward acceleration sensor is, for example, a sprung acceleration sensor (spring acceleration sensor) which is attached to a sprung member (for example, a vehicle body) in the vicinity of a suspension of each of wheels WH, and/or an unsprung acceleration sensor (unspring acceleration sensor) which is attached to an unsprung member (for example, a lower arm) in the vicinity of the suspension of each of the wheels WH. The information, which is detected by the predetermined acceleration detection sensor 106, is delivered to the control unit 103.

The damper actuator 107 changes changing the damping force characteristic (damping coefficient or attenuation coefficient) of a damper (not shown) attached to the suspension of each of the wheels WH. The damping force characteristic of the damper is changed continuously or in a stepwise manner by changing, for example, the cross-sectional area of the flow passage for the viscous fluid (for example, oil) formed in the damper. The damper actuator 107 is operated by the electric power supplied from an unillustrated battery carried on the autonomous traveling vehicle 100. Note that the method for changing the damping force characteristic of the damper is not limited thereto. It is also allowable to use any other known method.

The control unit 103 is a computer which controls the operation of the autonomous traveling vehicle 100 on the basis of the information acquired from the surrounding situation detection sensor 101 and which controls the damper actuator 107 on the basis of the information acquired from the predetermined acceleration detection sensor 106. The control unit 103 is configured, for example, by a microcomputer. The control unit 103 of this embodiment has, as functional modules, an operation plan generating unit 1031, an environment detecting unit 1032, a traveling control unit 1033, and a vibration suppression control unit 1034. The respective functional modules may be realized by executing programs stored in the storage unit such as ROM (Read Only Memory) or the like by CPU (Central Processing Unit) (any of them is not shown).

The operation plan generating unit 1031 acquires the operation command from the server apparatus 200 to generate the operation plan of the subject vehicle. In this embodiment, the operation plan is the data that prescribes the route along which the autonomous traveling vehicle 100 travels and the process which is to be performed by the autonomous traveling vehicle 100 in a part of or all of the route. For example, the followings are exemplified as examples of the data included in the operation plan.

(1) Data in which Route for Allowing Subject Vehicle to Travel Therealong is Represented by Set of Road Links

The “route for allowing the subject vehicle to travel therealong” referred to herein may be generated by the operation plan generating unit 1031, for example, on the basis of the given departure point and the destination point while making reference to the map data stored in the storage apparatus carried on the autonomous traveling vehicle 100. Alternatively, the “route for allowing the subject vehicle to travel therealong” may be generated by utilizing any external service, or it may be provided from the server apparatus 200.

(2) Data which Represents Process to be Performed by Subject Vehicle at Point on Route

The process to be performed by the subject vehicle includes, for example, “allow passengers to get on/off”, “load/unload cargoes”, and “stop for a predetermined period for passenger's sightseeing”. However, there is no limitation thereto.

The environment detecting unit 1032 detects the environment around the vehicle on the basis of the data acquired by the surrounding situation detection sensor 101. The object of the detection is, for example, the number and the position of the lane(s), the number and the position of the vehicle(s) existing around the subject vehicle, the number and the position of the obstacle(s) (for example, pedestrian(s), bicycle(s), structure(s), and building(s)) existing around the subject vehicle, the structure of the road, and the road sign. However, there is no limitation thereto. The detection target may be anyone provided that the object is required to perform the autonomous traveling. Further, the environment detecting unit 1032 may perform the tracking for the detected object. For example, the relative velocity of the object may be determined from the difference between the coordinates of the object detected one step before and the present coordinates of the object.

The traveling control unit 1033 controls the traveling of the subject vehicle on the basis of the operation plan generated by the operation plan generating unit 1031, the environment data generated by the environment detecting unit 1032, and the position information of the subject vehicle acquired by the position information acquiring unit 102. For example, the subject vehicle is allowed to travel so that the subject vehicle travels along a predetermined route and any obstacle does not enter a predetermined safe area provided around the subject vehicle as the center. Note that as for the method for allowing the subject vehicle to perform the autonomous traveling, it is possible to adopt any known method.

The vibration suppression control unit 1034 controls the damper actuator 107 of each of the wheels WH so that the predetermined acceleration described above approaches the target acceleration set by the server apparatus 200 (vibration attenuating process). In the vibration attenuating process, for example, if at least one of the sprung accelerations of the plurality of wheels WH, at least one of the unsprung accelerations of the plurality of wheels WH, the lateral acceleration of the autonomous traveling vehicle 100, or the front-back acceleration of the autonomous traveling vehicle 100 exceeds a predetermined threshold value, then the vibration suppression control unit 1034 individually calculates the damping force characteristic (damping coefficient or attenuation coefficient) of the damper of each of the wheels WH on the basis of the predetermined acceleration acquired by the predetermined acceleration detection sensor 106 (sprung acceleration of each of the wheels WH, unsprung acceleration of each of the wheels WH, lateral acceleration of the autonomous traveling vehicle 100, and front-back acceleration of the autonomous traveling vehicle 100), and the vibration suppression control unit 1034 controls the damper actuator 107 of each of the wheels WH in accordance with the calculated damping force characteristic (damping coefficient or attenuation coefficient). Accordingly, the vibration of the autonomous traveling vehicle 100 (vibration of the body) is attenuated. The “predetermined threshold value” referred to herein is the value which is set while being correlated with the sprung acceleration, the unsprung acceleration, the lateral acceleration, and the front-back acceleration respectively. The “predetermined threshold value” is the value which is changed depending on the target acceleration corresponding to each of the accelerations. For example, the predetermined threshold value of each of the accelerations is set to a small value when the target acceleration corresponding to each of the accelerations is small as compared with when the target acceleration corresponding to each of the accelerations is large. Note that as for the method for calculating the damping force characteristic (damping coefficient or attenuation coefficient) of the damper, it is possible to adopt any known method. Further, the predetermined acceleration is not limited to one which includes all of the sprung acceleration, the unsprung acceleration, the lateral acceleration, and the front-back acceleration. It is enough that the predetermined acceleration includes at least one of them. In accordance therewith, as for the target acceleration and the predetermined threshold value described above, it is also appropriate to set those corresponding to the acceleration component included in the predetermined acceleration.

The driving unit 104 allows the autonomous traveling vehicle 100 to travel on the basis of the command generated by the traveling control unit 1033. The driving unit 104 is configured to include, for example, a motor (for example, an internal combustion engine, an electric motor, or a hybrid mechanism of an internal combustion engine and an electric motor), a braking apparatus, and a steering arrangement (steering gear).

The communication unit 105 connects the autonomous traveling vehicle 100 to the network. In this embodiment, the communication can be performed with any other apparatus (for example, the server apparatus 200) via the network by utilizing the mobile communication service such as 3G (3rd Generation), LTE (Long Term Evolution) or the like. Note that the communication unit 105 may further comprise any communication unit type for performing the inter-vehicle communication with respect to any other autonomous traveling vehicle 100.

Next, the server apparatus 200 will be explained. The server apparatus 200 is the apparatus which manages the traveling positions of the plurality of autonomous traveling vehicles 100 and which transmits the operation commands. Further, the server apparatus 200 also has such a function that the target acceleration described above is set depending on the way of use of the individual autonomous traveling vehicle 100. The server apparatus 200 as described above is configured to have a communication unit 201, a control unit 202, and a storage unit 203. The communication unit 201 is a communication interface for performing the communication with the autonomous traveling vehicle 100 via the network in the same manner as the communication unit 105.

The control unit 202 administers the control of the server apparatus 200. The control unit 202 is configured, for example, by CPU. The control unit 202 of this embodiment has, as functional modules, a position information managing unit 2021, an operation command generating unit 2022, a required vibration suppression level acquiring unit 2023, and a target acceleration setting unit 2024. These functional modules may be realized by executing programs stored in the storage unit such as ROM or the like by CPU (any of them is not shown).

The position information managing unit 2021 manages the positions of the plurality of autonomous traveling vehicles 100 under the management of the server apparatus 200. Specifically, the position information managing unit 2021 receives the position information transmitted from the plurality of autonomous traveling vehicles 100 at every predetermined cycle, and the position information managing unit 2021 stores the received position information in the storage unit 203 as described later on while being correlated with the date and time.

The operation command generating unit 2022 determines the autonomous traveling vehicle 100 to be dispatched when a vehicle allocation request for the autonomous traveling vehicle 100 is received from the outside, and the operation command generating unit 2022 generates the operation command corresponding to the vehicle allocation request. The vehicle allocation request includes, for example, the followings. However, it is also allowable to provide any other request.

### (1) Transport Request for Cargoes and Passengers

This request is to perform the transport of cargoes and passengers by designating the departure point and the destination point, or the predetermined visitation route.

### (2) Dispatch Request for Autonomous Traveling Vehicle Having Specified Function in Combination

This request is to ask the dispatch of the autonomous traveling vehicle 100 having the function of, for example, the lodging facilities for passengers (hotel) or the workspace for passengers (for example, private office or business office). As for the dispatch destination, either a single point is available, or a plurality of points are available. If a plurality of dispatch destinations are designated, it is also allowable to provide the service at the plurality of points respectively.

The vehicle allocation request as described above is acquired from the user or customer, for example, via the internet. Note that it is not necessarily indispensable that the transmission source of the vehicle allocation request should be any general user. The transmission source of the vehicle allocation request may be, for example, an entrepreneur who operates the autonomous traveling vehicle 100 or a forwarding agent who undertakes the transports of cargoes. The autonomous traveling vehicle 100, which is the transmission destination of the operation command, is determined depending on, for example, the position information of each vehicle acquired by the position information managing unit 2021 and the specification of each vehicle (for what way of use the vehicle has its interior/exterior equipment) previously grasped by the server apparatus 200. Then, if the autonomous traveling vehicle 100, which is the transmission destination of the operation command, is determined, the operation command, which is generated by the operation command generating unit 2022, is transmitted to the autonomous traveling vehicle 100 by the communication unit 201. Note that if the autonomous traveling vehicle 100, which is the transmission destination of the operation command, is used as a cargo transport vehicle, the target acceleration, which is set by the target acceleration setting unit 2024 as described later on, is also transmitted to the autonomous traveling vehicle 100, in addition to the operation command generated by the operation command generating unit 2022.

The required vibration suppression level acquiring unit 2023 acquires the required vibration suppression level of the cargo to be transported by the autonomous traveling vehicle 100, when the autonomous traveling vehicle 100, which is the transmission destination of the operation command generated by the operation command generating unit 2022 described above, is used as a cargo transport vehicle. In this embodiment, the required vibration suppression level of the cargo is previously categorized depending on the classification of the cargo. In this embodiment, as described above, precision machines, electronic equipment, glass products and the like, for which the vibration during the transport easily affects the quality, are classified into the “delicate cargo”, and clothing, food, books and the like, for which the vibration during the transport hardly affects the quality, are classified into the “ordinary cargo”. However, there is no limitation thereto. The cargoes may be categorized into three or more classifications. Then, the required vibration suppression level is determined for each of the classifications. In this embodiment, the required vibration suppression level of the cargo classified into the delicate cargo is set to be higher than the required vibration suppression level of the cargo classified into the ordinary cargo. Note that the correlating relationship between the cargo classification and the required vibration suppression level is stored in the storage unit 203 in a form in which the required vibration suppression level can be derived by using the classification of the cargo as an argument as described later on. Accordingly, the required vibration suppression level acquiring unit 2023 acquires the classification of the cargo loaded on the autonomous traveling vehicle 100, and thus it is possible to derive the required vibration suppression level by using the classification of the cargo as the argument. In this case, as for the method for acquiring the classification of the cargo, it is possible to utilize, for example, a method in which the classification is provided by the user (for example, the forwarder of the cargo, the receiver of the cargo, and the entrepreneur who undertook the transport of the cargo) (for example, a method in which the classification of the cargo is included in the vehicle allocation request), or a method in which a tag for indicating the classification is attached to the packaging material of the cargo and the tag is read by a reader apparatus installed for the autonomous traveling vehicle 100 so that the classification read by the reader apparatus is thereby transmitted from the autonomous traveling vehicle 100 to the server apparatus 200.

The target acceleration setting unit 2024 sets the target acceleration adequate for the required vibration suppression level of the cargo acquired by the required vibration suppression level acquiring unit 2023. In particular, if the required vibration suppression level, which is acquired by the required vibration suppression level acquiring unit 2023, is high, the target acceleration setting unit 2024 sets the target acceleration so that the predetermined acceleration described above (sprung acceleration, unsprung acceleration, lateral acceleration, and front-back acceleration) is suppressed to be small. Accordingly, the vibration suppression performance of the autonomous traveling vehicle 100 is enhanced during the transport of the cargo. Therefore, it is possible to suppress the deterioration of the quality of the cargo which would be otherwise caused by the vibration of the autonomous traveling vehicle 100. Thus, it is possible to raise the transport quality of the cargo.

In this context, if the target acceleration is set so that the predetermined acceleration described above is suppressed to be small, the predetermined threshold value described above is also decreased in accordance therewith. Therefore, the number of times of the occurrence of the situation in which the predetermined acceleration exceeds the predetermined threshold value increases with ease. On account thereof, the frequency of the operation of the damper actuator 107 is increased. Therefore, the electric power, which is consumed to operate the damper actuator 107, is increased, and the electricity efficiency of the autonomous traveling vehicle 100 is deteriorated. If the electricity efficiency of the autonomous traveling vehicle 100 is deteriorated for the reason as described above, then the cruising distance of the autonomous traveling vehicle 100 is decreased, and hence there is a possibility that the transport cost may be increased for passengers and cargoes. On this account, if the target acceleration, which is equivalent to that provided when the delicate cargo is transported, is set when the cargo such as the cargo identified to be the ordinary cargo, for which the vibration of the autonomous traveling vehicle 100 hardly affects the quality, is transported, then the transport cost of the cargo is unnecessarily increased on account of the decrease in the cruising distance of the autonomous traveling vehicle 100, and there is a possibility that the monetary burden of the transport agent, the cargo owner or the like may be unnecessarily increased as well.

In view of the above, in this embodiment, the target acceleration setting unit 2024 sets difference target accelerations depending on the required vibration suppression level of the cargo transported by the autonomous traveling vehicle 100. That is, the target acceleration is set so that the predetermined acceleration is suppressed to be smaller when the required vibration suppression level of the cargo transported by the autonomous traveling vehicle 100 is high as compared with when the required vibration suppression level of the cargo transported by the autonomous traveling vehicle 100 is low. When the target acceleration is set depending on the required vibration suppression level of the cargo transported by the autonomous traveling vehicle 100 as described above, if the cargo, for which the priority is given to the transport quality as compared with the transport cost, is transported by the autonomous traveling vehicle 100, for example, if the cargo, which is classified into the delicate cargo, is transported by the autonomous traveling vehicle 100, then the vibration, in which the predetermined acceleration is relatively small, is also attenuated in addition to the vibration in which the predetermined acceleration is relatively large. Therefore, it is possible to raise the vibration suppression performance of the autonomous traveling vehicle 100. Accordingly, the vibration, which acts on the cargo, can be suppressed to be small. Therefore, it is possible to suppress the deterioration of the quality of the cargo which would be caused by the vibration of the autonomous traveling vehicle 100. On the other hand, if the cargo, for which the priority is given to the transport cost as compared with the transport quality, is transported by the autonomous traveling vehicle 100, for example, if the cargo, which is classified into the ordinary cargo, is transported by the autonomous traveling vehicle 100, then the vibration, in which the predetermined acceleration is relatively large, is attenuate, while the vibration, in which the predetermined acceleration is relatively small, is not attenuated. Therefore, it is possible to suppress the operation frequency of the damper actuator 107 to be small. Accordingly, the deterioration of the electricity efficiency, which is caused by the operation of the damper actuator 107, is suppressed. Therefore, the decrease in the cruising distance of the autonomous traveling vehicle 100 can be suppressed to be small, and thus the monetary burden of the transport agent, the cargo owner or the like can be suppressed to be small. Note that the target acceleration as described above is stored in the storage unit 203 described later on while being correlated with the individual required vibration suppression level. Accordingly, the target acceleration setting unit 2024 can derive the target acceleration adequate for the required vibration suppression level by accessing the storage unit 203 by using, as an argument, the required vibration suppression level of the cargo transported by the autonomous traveling vehicle 100.

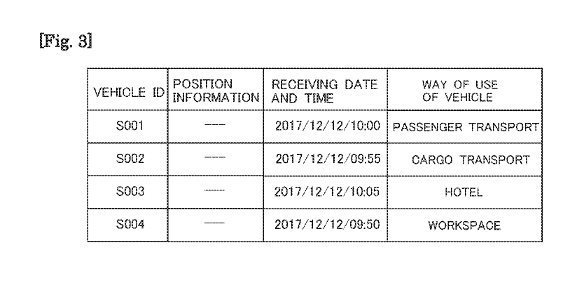

The storage unit 203 stores the information. The storage unit 203 is configured by a storage medium such as RAM, a magnetic disk, a flash memory or the like. The vehicle information concerning the individual autonomous traveling vehicle 100 is stored in the storage unit 203 of this embodiment in which the vehicle information is linked to the identification information of the individual autonomous traveling vehicle 100. An explanation will now be made on the basis of FIG. 3 about exemplary configuration of the vehicle information stored in the storage unit 203. FIG. 3 indicates the table configuration of the vehicle information. The vehicle information table shown in FIG. 3 has respective fields of, for example, the vehicle ID, the position information, the date and time of the receiving, and the way of use of the vehicle. The vehicle identification information, which is provided to identify the individual autonomous traveling vehicle 100, is inputted into the vehicle ID field. The position information, which is received by the position information managing unit 2021 from the individual autonomous traveling vehicle 100, is inputted into the position information field. The position information, which is inputted into the position information field, may be, for example, the information which indicates the address of the place at which the autonomous traveling vehicle 100 is positioned, or the information which indicates the coordinates (latitude, longitude) on a map of the place at which the autonomous traveling vehicle 100 is positioned. The date and time, at which the position information inputted into the position information field described above is received by the position information managing unit 2021 from the autonomous traveling vehicle 100, is inputted into the receiving date and time field. Note that it is assumed that the information, which is inputted into the position information field and the receiving date and time field, is updated every time when the position information managing unit 2021 receives the position information from each of the autonomous traveling vehicles 100 (in the predetermined cycle described above). Then, the information, which indicates the way of use of the autonomous traveling vehicle 100, is inputted into the way of use of vehicle field. For example, if the way of use of the autonomous traveling vehicle 100 is a pickup bus, an on-demand taxi or the like having the purpose to transport the passenger only, “passenger transport” is inputted. If the way of use of the autonomous traveling vehicle 100 is a cargo transport vehicle or the like having the purpose to transport the cargo only, “cargo transport” is inputted. If the way of use of the autonomous traveling vehicle 100 is a staying type transport vehicle having the purpose to lodge and transport the passenger, “hotel” is inputted. If the way of use of the autonomous traveling vehicle 100 is a staying type transport vehicle having the purpose to provide the workspace for the passenger and transport the passenger, “workspace” is inputted. Note that it is assumed that the information, which is inputted into the way of use of vehicle field, is updated every time when the specification of each of the autonomous traveling vehicles 100 is changed.

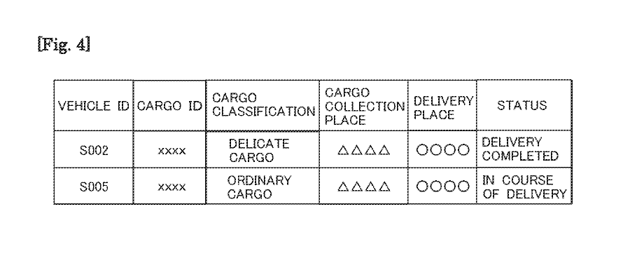

Further, the cargo information, in which the autonomous traveling vehicle 100 used as the cargo transport vehicle is linked to the information in relation to the cargo loaded on the autonomous traveling vehicle 100, is also stored in the storage unit 203. An explanation will now be made on the basis of FIG. 4 about exemplary configuration of the cargo information stored in the storage unit 203. FIG. 4 indicates the table configuration of the cargo information. The cargo information table shown in FIG. 4 has respective fields of, for example, the vehicle ID, the cargo ID, the cargo classification, the cargo collection place, the delivery place, and the status. The vehicle identification information for identifying the individual autonomous traveling vehicle 100 is inputted into the vehicle ID field. The vehicle identification information, which is inputted into the vehicle ID field, is the same as the information which is inputted into the vehicle ID field of the vehicle information table shown in FIG. 3. The cargo identification information, which is provided to identify the individual cargo, is inputted into the cargo ID field. The information, which indicates the classification of the cargo as categorized on the basis of the easiness of the influence of the vibration exerted on the quality of the cargo, is inputted into the cargo classification field. For example, if the classification of the cargo is the delicate cargo, “delicate cargo” is inputted. If the classification of the cargo is the ordinary cargo, “ordinary cargo” is inputted. The information, which indicates the classification of the cargo, may be inputted on the basis of the information included in the vehicle allocation request as described above. Alternatively, the information, which indicates the classification of the cargo, may be inputted on the basis of the information received from the autonomous traveling vehicle 100. The information, which indicates the cargo collection point (departure point) to load the cargo on the autonomous traveling vehicle 100, is inputted into the collection place field. The information, which indicates the delivery point (destination point) to unload the cargo from the autonomous traveling vehicle 100, is inputted into the delivery place field. Note that the information which indicates the departure point inputted into the cargo collection place and the information which indicates the destination point inputted into the delivery place field may be, for example, the information which indicates the addresses of the departure point and the destination point, or the information which indicates the coordinates (latitude, longitude) on a map of the departure point and the destination point. Further, the information, which indicates whether or not the delivery of the cargo is completed, is inputted into the status field. For example, if the delivery of the cargo is completed, “delivery completed” is inputted. If the delivery of the cargo is not completed, “in course of delivery” is inputted.

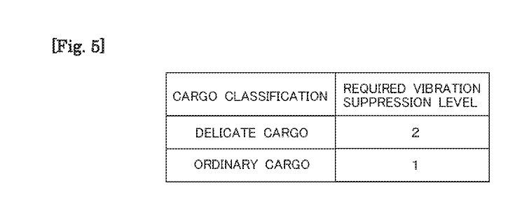

Further, the required vibration suppression level information, in which the required vibration suppression level is linked to every classification of the cargo, is also stored in the storage unit 203. An explanation will now be made on the basis of FIG. 5 about exemplary configuration of the required vibration suppression level information stored in the storage unit 203. FIG. 5 indicates the table configuration of the required vibration suppression level information. The required vibration suppression level information table shown in FIG. 5 has the cargo classification field and the required vibration suppression level field. The classification of the cargo is inputted into the cargo classification field. The classification of the cargo, which is inputted into the cargo classification field, is the information which is categorized on the same basis as that of the information inputted into the cargo classification field of the cargo information table shown in FIG. 4 described above. The information, which indicates the required vibration suppression level adequate for the individual classification, is inputted into the required vibration suppression level field. For example, if the classification of the cargo is the “delicate cargo”, “2” is inputted. If the classification of the cargo is the “ordinary cargo”, “1” is inputted. Note that the information, which is inputted into the required vibration suppression level field shown in FIG. 5, is not limited to the numeral. It is appropriate that the information makes it possible to identify that the required vibration suppression level of the delicate cargo is higher than the required vibration suppression level of the ordinary cargo.

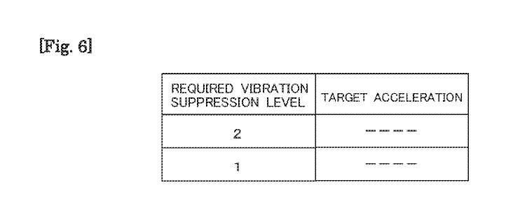

Further, the target acceleration information, in which the target acceleration is linked to every classification of the cargo, is also stored in the storage unit 203. An explanation will now be made on the basis of FIG. 6 about exemplary configuration of the target acceleration information stored in the storage unit 203. FIG. 6 indicates the table configuration of the target acceleration information. The target acceleration information table shown in FIG. 6 has the required vibration suppression level field and the target acceleration field. The information (for example, “1” or “2”), which indicates the required vibration suppression level, is inputted into the required vibration suppression level field. The required vibration suppression level information, which is inputted into the required vibration suppression level field, is the information which is categorized on the same basis as that of the information inputted into the required vibration suppression level field of the required vibration suppression level information field shown in FIG. 5 described above. Further, the target acceleration, which is adequate for the individual required vibration suppression level, is inputted into the target acceleration field. For example, if the required vibration suppression level is “2”, the target acceleration, which is set so that the predetermined acceleration is suppressed to be smaller, is inputted, as compared with if the required vibration suppression level is “1”.

The target acceleration information table shown in FIG. 6 is illustrative of the exemplary case in which the target acceleration is set while considering the required vibration suppression level of the cargo. However, the target acceleration may be set while considering the specifications (for example, size or dimension, weight, wheel base, and tread) of the autonomous traveling vehicle 100 as well in addition to the required vibration suppression level. For example, even when the required vibration suppression level is identical, the heave vibration, the roll vibration, and the pitch vibration are easily increased if the wheel base and/or the tread of the autonomous traveling vehicle 100 used as the cargo transport vehicle is/are small as compared with if the wheel base and/or the tread is/are large. Therefore, the target acceleration may be set so that the predetermined acceleration is suppressed to be smaller.

Further, when the cargo is not loaded on the autonomous traveling vehicle 100, for example, when the autonomous traveling vehicle 100 travels toward the cargo collection point, or when the autonomous traveling vehicle 100 returns from the delivery point to a garage or the like, then any target acceleration, which is different from that provided when the cargo is loaded on the autonomous traveling vehicle 100, may be set. For example, when the cargo is not loaded on the autonomous traveling vehicle 100, the electricity efficiency of the autonomous traveling vehicle 100 may be improved by not executing the vibration attenuating process described above.

Note that the target acceleration, which is inputted into the target acceleration field of the target acceleration information table described above, may be previously determined on the basis of a result of any experiment or simulation. Further, the target acceleration, which is inputted into the target acceleration field described above, may be appropriately updated on the basis of the evaluation of, for example, a personnel for security or a personnel for collection and delivery who got on the autonomous traveling vehicle 100 when the autonomous traveling vehicle 100 was actually operated.

### (Operation Action of Autonomous Traveling Vehicle)

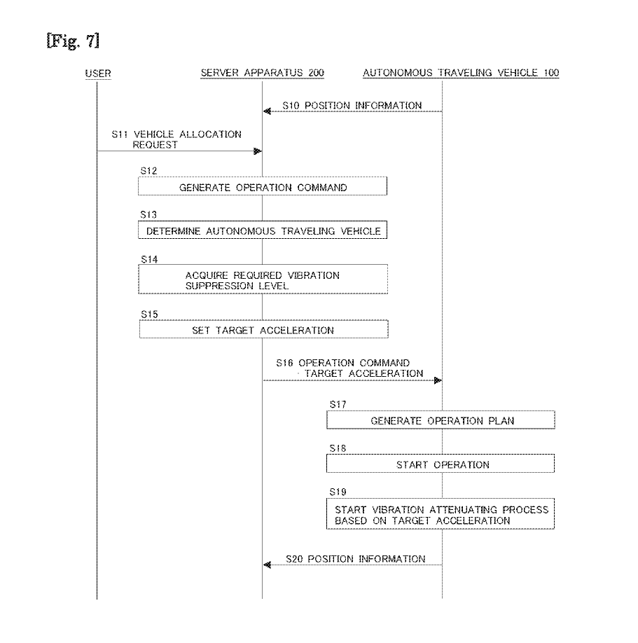

An explanation will now be made about the processes performed by the respective constitutive components described above. FIG. 7 explains the data flow until the autonomous traveling vehicle 100 starts the operation after the server apparatus 200 generates the operation command on the basis of a vehicle allocation request of a user. Note that the autonomous traveling vehicle 100 shown in FIG. 7 is the vehicle used as the cargo transport vehicle.

Each of the autonomous traveling vehicles 100 notifies the server apparatus 200 of the position information at a predetermined cycle. In this procedure, the signal, which is transmitted from the autonomous traveling vehicle 100 to the server apparatus 200, includes the identification information (vehicle ID) of the autonomous traveling vehicle 100 in addition to the position information of the autonomous traveling vehicle 100. If the position information and the vehicle ID sent from the autonomous traveling vehicle 100 are received by the communication unit 201 of the server apparatus 200 (Step S10), then the position information managing unit 2021 accesses the vehicle information stored in the storage unit 203, and the information of the receiving data and time field and the position information field of the vehicle information table corresponding to the vehicle ID is updated.

If the user transmits the vehicle allocation request to the server apparatus 200 by the aid of unillustrated communication unit, the vehicle allocation request is received by the communication unit 201 of the server apparatus 200 (Step S11). In this case, the vehicle allocation request described above also includes the information concerning the classification of the cargo as the transport object, in addition to the information of, for example, the cargo collection point (departure point) for loading the cargo on the autonomous traveling vehicle 100, the delivery point (destination point) for unloading the cargo from the autonomous traveling vehicle 100, the preferred date and time for the cargo collection, and the preferred date and time for the delivery.

In Step S12, the operation command generating unit 2022 generates the operation command in accordance with the vehicle allocation request. The operation command may designate the cargo collection point, the delivery point, the preferred date and time for the cargo collection, and the preferred date and time for the delivery. Alternatively, the operation command may designate the traveling route in addition to the designation of those described above. The operation command may further include the information concerning the process to be performed in the course of the traveling route and the service to be provided.

In Step S13, the operation command generating unit 2022 selects the autonomous traveling vehicle 100 adequate for the vehicle allocation request. For example, the operation command generating unit 2022 firstly makes reference to the vehicle information table of the storage unit 203 to extract all of the autonomous traveling vehicles 100 which have the facilities adequate for the way of use of the vehicle of the vehicle allocation request and which can be operated in the period ranging from the preferred date and time for the cargo collection to the preferred date and time for the delivery. Subsequently, the operation command generating unit 2022 selects one autonomous traveling vehicle 100 which can be moved to the cargo collection point until the preferred date and time for the cargo collection on the basis of the respective pieces of position information of the extracted autonomous traveling vehicles 100. When the autonomous traveling vehicle 100, which is adequate for the vehicle allocation request described above, is selected by the operation command generating unit 2022, the cargo identification information is allotted to the cargo as the transport object. The cargo identification information is stored in the storage unit 203 (corresponding to the cargo information table shown in FIG. 4), while being linked to the vehicle ID of the autonomous traveling vehicle 100 selected by the operation command generating unit 2022 together with the information about the cargo collection point, the information about the delivery point, and the information about the cargo classification extracted from the vehicle allocation request described above. When the cargo information table is generated as described above, the vehicle ID of the autonomous traveling vehicle 100 selected by the operation command generating unit 2022 is delivered from the operation command generating unit 2022 to the required vibration suppression level acquiring unit 2023.

In Step S14, the required vibration suppression level acquiring unit 2023 acquires the required vibration suppression level of the cargo transported by the autonomous traveling vehicle 100 selected by the operation command generating unit 2022. In particular, the required vibration suppression level acquiring unit 2023 firstly accesses the cargo information table of the storage unit 203 on the basis of the vehicle ID accepted from the operation command generating unit 2022, and thus the required vibration suppression level acquiring unit 2023 derives the cargo classification linked to the vehicle ID. Subsequently, the required vibration suppression level acquiring unit 2023 accesses the required vibration suppression level information table of the storage unit 203 (see FIG. 5) by using, as the argument, the cargo classification derived from the cargo information table, and thus the required vibration suppression level acquiring unit 2023 derives the required vibration suppression level corresponding to the cargo classification. When the required vibration suppression level is acquired as described above, the acquired required vibration suppression level is delivered from the required vibration suppression level acquiring unit 2023 to the target acceleration setting unit 2024.

In Step S15, the target acceleration setting unit 2024 sets the target acceleration which is adequate for the required vibration suppression level accepted from the required vibration suppression level acquiring unit 2023. Specifically, the target acceleration setting unit 2024 accesses the target acceleration information table of the storage unit 203 by using, as the argument, the required vibration suppression level accepted from the required vibration suppression level acquiring unit 2023, and thus the target acceleration setting unit 2024 derives the target acceleration linked to the required vibration suppression level.

In Step S16, the operation command generated by the operation command generating unit 2022 and the target acceleration set by the target acceleration setting unit 2024 are transmitted from the communication unit 201 of the server apparatus 200 to the autonomous traveling vehicle 100 selected by the operation command generating unit 2022.

If the operation command and the target acceleration transmitted from the server apparatus 200 are received by the communication unit 105 of the autonomous traveling vehicle 100, the operation plan generating unit 1031 of the autonomous traveling vehicle 100 generates the operation plan on the basis of the operation command received from the server apparatus 200 (Step S17). The operation plan, which is generated by the operation plan generating unit 1031, is delivered to the traveling control unit 1033. Then, the traveling control unit 1033 starts the operation of the autonomous traveling vehicle 100 in accordance with the operation plan accepted from the operation plan generating unit 1031 (Step S18).

When the operation of the autonomous traveling vehicle 100 by the traveling control unit 1033 is started, the vibration suppression control unit 1034 controls the damper actuators 107 of the respective wheels WH so that the predetermined acceleration of the autonomous traveling vehicle 100 approaches the target acceleration received from the server apparatus 200 (Step 19). Specifically, the vibration suppression control unit 1034 firstly determines the predetermined threshold value described above on the basis of the target acceleration received from the server apparatus 200. Subsequently, if at least one of the sprung accelerations of the plurality of wheels WH, at least one of the unsprung accelerations of the plurality of wheels WH, the lateral acceleration of the autonomous traveling vehicle 100, or the front-back acceleration of the autonomous traveling vehicle 100 exceeds the predetermined threshold value described above, then the vibration suppression control unit 1034 individually calculates the damping force characteristic (damping coefficient or attenuation coefficient) of the damper of each of the wheels WH on the basis of the predetermined acceleration acquired by the predetermined acceleration detection sensor 106 (for example, the sprung acceleration of each of the wheels WH, the unsprung acceleration of each of the wheels WH, the lateral acceleration of the autonomous traveling vehicle 100, or the front-back acceleration of the autonomous traveling vehicle 100), and the vibration suppression control unit 1034 controls the damper actuator 107 of each of the wheels WH in accordance with the calculated damping force characteristic (damping coefficient or attenuation coefficient). In this procedure, if the classification of the cargo transported by the autonomous traveling vehicle 100 is the delicate cargo, the target acceleration is set so that the predetermined acceleration is suppressed to be smaller, as compared with if the classification of the cargo transported by the autonomous traveling vehicle 100 is the ordinary cargo. Therefore, the vibration, in which the predetermined acceleration is relatively small, is also attenuated, in addition to the vibration in which the predetermined acceleration is relatively large. As a result, when the cargo, for which the vibration easily affects the quality, is transported by the autonomous traveling vehicle 100, it is possible to suppress the deterioration of the quality of the cargo. On the other hand, if the classification of the cargo transported by the autonomous traveling vehicle 100 is the ordinary cargo, the vibration, in which the predetermined acceleration is relatively large, is attenuated, although the vibration, in which the predetermined acceleration is relatively small, is not attenuated. As a result, when the cargo, for which the vibration hardly affects the quality, is transported by the autonomous traveling vehicle 100, the decrease in the cruising distance, which is caused by the operation of the damper actuator 107, can be suppressed to be small, while suppressing the deterioration of the quality of the cargo. Thus, the monetary burden of, for example, the transport agent and/or the cargo owner can be suppressed to be small.

Note that the transmission of the position information from the autonomous traveling vehicle 100 to the server apparatus 200 is also performed repeatedly at the predetermined cycle even after the start of the operation of the autonomous traveling vehicle 100 (Step S20). Accordingly, the server apparatus 200 can grasp, for example, the position and the operation state of the autonomous traveling vehicle 100 during the operation of the autonomous traveling vehicle 100 as well.

According to the embodiment described above concerning the control apparatus for the vehicle in which the vibration of the autonomous traveling vehicle 100 is attenuated by adjusting the parameter which affects the predetermined acceleration of the autonomous traveling vehicle 100, it is possible to realize the transport quality and the transport cost corresponding to the required vibration suppression level of the cargo, when the cargo is transported by the autonomous traveling vehicle 100.

### Second Embodiment

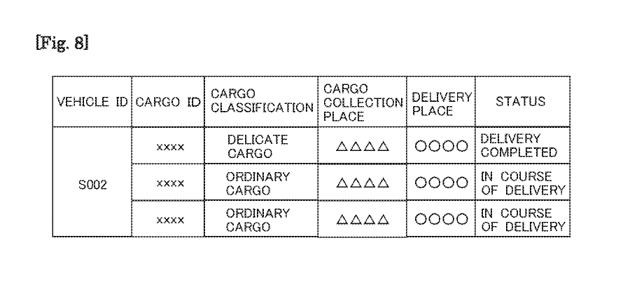

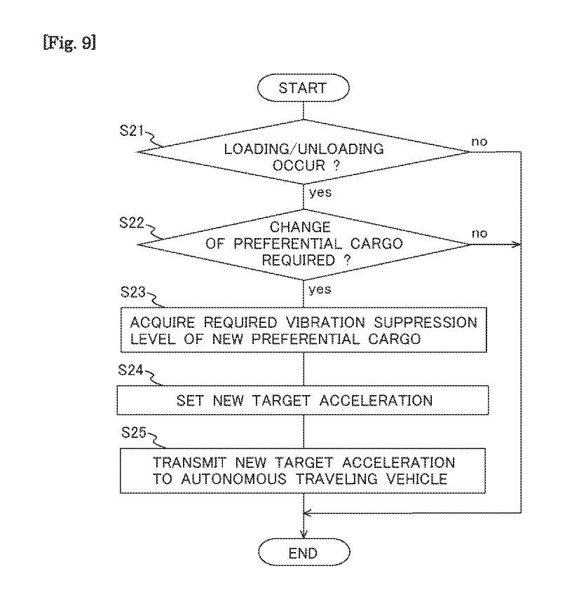

Next, a second embodiment of the present disclosure will be explained on the basis of FIGS. 8 and 9. In this section, constitutive components, which are different from those of the first embodiment described above, will be explained, and the same or equivalent constitutive components are omitted from the explanation. In the first embodiment described above, the case has been described, in which one cargo is loaded on one autonomous traveling vehicle 100. However, in this embodiment, an explanation will be made about a case in which a plurality of cargoes are loaded on one autonomous traveling vehicle 100.

Assuming that the autonomous traveling vehicle 100 is effectively utilized as the cargo transport vehicle, it is effective to transport a plurality of cargoes by way of one autonomous traveling vehicle 100. In such a situation, it is desirable that the cargoes, which are loaded on each of the autonomous traveling vehicles 100, are managed on the side of the server apparatus 200 so that the required vibration suppression levels of all of the cargoes loaded on the individual autonomous traveling vehicle 100 are an identical level. However, for example, if a large number of vehicle allocation requests are generated in a duplicated manner, such a situation may arise that a plurality of cargoes having different required vibration suppression levels are loaded in a mixed manner on one autonomous traveling vehicle 100. In such a situation, if the target acceleration is set in conformity with the cargo having the lowest required vibration suppression level of the plurality of cargoes, or if the target acceleration is set in conformity with the average value of the required vibration suppression levels of the plurality of cargoes, then it is feared that the quality of the cargo having the high required vibration suppression level may not be secured.

In view of the above, in this embodiment, if it is necessary that a plurality of cargoes, which have different required vibration suppression levels, are transported by one autonomous traveling vehicle 100, the target acceleration is set in conformity with the cargo having the highest required vibration suppression level of the plurality of cargoes. In order to realize such a method, in this embodiment, the cargo information table, which is stored in the storage unit 203, is configured as shown in FIG. 8. That is, in the cargo information table of this embodiment, pieces of the identification information (cargo ID), the cargo classifications, the cargo collection places, the delivery places, and the statuses of all of the cargoes transported by the autonomous traveling vehicle 100 are linked to the vehicle identification information (vehicle ID) of one autonomous traveling vehicle 100. Note that the information, which is the same as or equivalent to the information of the cargo information table shown in FIG. 4 described above, is inputted into each of the fields of the cargo ID, the cargo classification, the cargo collection place, the delivery place, and the status. The cargo information table configured as described above is generated by the operation command generating unit 2022 on the basis of one or a plurality of vehicle allocation request or requests.

The required vibration suppression level acquiring unit 2023 of this embodiment derives the classifications of all of the cargoes linked to the vehicle ID by accessing the cargo information table shown in FIG. 8 on the basis of the vehicle ID delivered from the operation command generating unit 2022. Subsequently, the required vibration suppression level acquiring unit 2023 derives the required vibration suppression levels of all of the cargoes by accessing the required vibration suppression level information table (see FIG. 5) of the storage unit 203 by using, as the argument, the cargo classification derived from the cargo information table. The plurality of required vibration suppression levels, which are acquired by the required vibration suppression level acquiring unit 2023, are delivered from the required vibration suppression level acquiring unit 2023 to the target acceleration setting unit 2024.

The target acceleration setting unit 2024 selects the highest required vibration suppression level of the plurality of required vibration suppression levels delivered from the required vibration suppression level acquiring unit 2023, and the target acceleration setting unit 2024 sets the target acceleration on the basis of the selected required vibration suppression level. That is, the target acceleration setting unit 2024 derives the target acceleration linked to the required vibration suppression level by accessing the target acceleration information table (see FIG. 6) of the storage unit 203 by using, as the argument, the highest required vibration suppression level of the plurality of required vibration suppression levels accepted from the required vibration suppression level acquiring unit 2023.

If the target acceleration is set by the method as described above, even when the plurality of cargoes having the different required vibration suppression levels are transported by one autonomous traveling vehicle 100, then the cargo such as the cargo classified into the delicate cargo described above, for which the vibration easily affects the quality, can be transported without deteriorating the quality thereof.

Note that when the plurality of cargoes are transported by one autonomous traveling vehicle 100, the delivery places of the cargoes are not necessarily identical. When the delivery places of the plurality of cargoes are different from each other, the respective cargoes are unloaded from the autonomous traveling vehicle 100 at the respective delivery places of the cargoes. If the cargo (hereinafter referred to as “preferential cargo” in some cases), which has the highest required vibration suppression level of those of the plurality of cargoes, is unloaded from the autonomous traveling vehicle 100, the vibration suppression performance, which is required for the autonomous traveling vehicle 100 in the transport step thereafter, is lowered. In such a situation, if the target acceleration after the unloading of the preferential cargo from the autonomous traveling vehicle 100 is continuously set to the same value as that previously used before the unloading of the preferential cargo from the autonomous traveling vehicle 100, then the electricity efficiency of the autonomous traveling vehicle 100 is unnecessarily deteriorated, and thus the cruising distance of the autonomous traveling vehicle 100 is unnecessarily decreased. Therefore, the increase in the transport cost is caused.

In view of the above, in this embodiment, if the preferential cargo described above is unloaded from the autonomous traveling vehicle 100 during the process in which the plurality of cargoes are transported by one autonomous traveling vehicle 100, the target acceleration is newly set at that point in time. Specifically, at first, the required vibration suppression level acquiring unit 2023 makes reference to the cargo information table shown in FIG. 8 described above to acquire the required vibration suppression levels of all of the cargoes for which the status is “in course of delivery” (i.e., the cargoes remaining on the vehicle at the point in time at which the preferential cargo is unloaded from the vehicle). Subsequently, the target acceleration setting unit 2024 derives the target acceleration linked to the required vibration suppression level by accessing the target acceleration information table of the storage unit 203 by using, as the argument, the highest required vibration suppression level of the required vibration suppression levels of all of the cargoes acquired by the required vibration suppression level acquiring unit 2023. Accordingly, the transport cost of the cargo can be lowered as far as possible without lowering the transport quality of the cargo.

Further, when a plurality of cargoes are transported by one autonomous traveling vehicle 100, the cargo collection places of the cargoes are not necessarily identical. If the cargo collection places of the plurality of cargoes are different from each other, the respective cargoes are loaded on the autonomous traveling vehicle 100 at the respective cargo collection places of the cargoes. Then, if any new cargo, which has a required vibration suppression level higher than that of the preferential cargo having been already loaded on the autonomous traveling vehicle 100, is loaded on the autonomous traveling vehicle 100, the vibration suppression performance, which is required for the autonomous traveling vehicle 100 in the transport step thereafter, is raised. In such a situation, if the target acceleration, which is to be provided after loading the new cargo on the autonomous traveling vehicle 100, is continuously set to the same value as that used before loading the new cargo on the autonomous traveling vehicle 100, it is difficult to secure the quality of the new cargo.

In view of the above, in this embodiment, if the new cargo, which has the required vibration suppression level higher than that of the preferential cargo having been already loaded, is loaded on the autonomous traveling vehicle 100 during the process in which the plurality of cargoes are transported by one autonomous traveling vehicle 100, the target acceleration is newly set at that point in time. Specifically, at first, the required vibration suppression level acquiring unit 2023 makes reference to the cargo information table shown in FIG. 8 described above to acquire the required vibration suppression levels of all of the cargoes including the cargo newly loaded on the autonomous traveling vehicle 100. Subsequently, the target acceleration setting unit 2024 derives the target acceleration linked to the required vibration suppression level by accessing the target acceleration information table of the storage unit 203 by using, as the argument, the highest required vibration suppression level of the required vibration suppression levels of all of the cargoes acquired by the required vibration suppression level acquiring unit 2023. Accordingly, it is possible to secure the quality of the new cargo described above.

An explanation will now be made with reference to FIG. 9 about the procedure for updating the target acceleration during the process for transporting the plurality of cargoes by one autonomous traveling vehicle 100. FIG. 9 indicates a flow chart illustrating a process routine executed by the server apparatus 200 when the loading/unloading of the cargo occurs with respect to the autonomous traveling vehicle 100.

In Step S21, the server apparatus 200 judges whether or not the loading/unloading of the cargo occurs with respect to the autonomous traveling vehicle 100. The judgment may be made by comparing the present position of the autonomous traveling vehicle 100 with the cargo collection place or the delivery place. Alternatively, the judgment may be made by accepting, for example, a delivery completion notice or a cargo collection completion notice from the autonomous traveling vehicle 100.

If the negative judgment is made in Step S21 described above, the server apparatus 200 terminates this process routine. On the other hand, if the affirmative judgment is made in Step S21 described above, the server apparatus 200 proceeds to Step S22 to judge whether or not the change of the preferential cargo is required. For example, if the preferential cargo is unloaded from the autonomous traveling vehicle 100 at the predetermined delivery place, or if the cargo, which has the required vibration suppression level higher than that of the preferential cargo having been already loaded, is loaded on the autonomous traveling vehicle 100 at the predetermined delivery place, then it is judged that the change of the preferential cargo is required.

If the negative judgment is made in Step S22 described above, the server apparatus 200 terminates this process routine without changing the target acceleration. On the other hand, if the affirmative judgment is made in Step S22 described above, the server apparatus 200 proceeds to Step S23 to acquire the required vibration suppression level of the new preferential cargo. In this procedure, if the prior preferential cargo is unloaded from the autonomous traveling vehicle 100 at the predetermined delivery place, the server apparatus 200 selects the cargo (new preferential cargo) having the highest required vibration suppression level of the cargoes remaining on the autonomous traveling vehicle 100 to acquire the required vibration suppression level of the selected cargo. Further, if the new cargo, which has the required vibration suppression level higher than that of the prior preferential cargo, is loaded on the autonomous traveling vehicle 100, the server apparatus 200 selects, as the new preferential cargo, the cargo which is newly loaded on the autonomous traveling vehicle 100. Subsequently, the server apparatus 200 acquires the required vibration suppression level of the new preferential cargo.

In Step S24, the server apparatus 200 derives the target acceleration adequate for the required vibration suppression level by accessing the target acceleration information table of the storage unit 203 by using, as the argument, the required vibration suppression level acquired in Step S23 described above. The derived target acceleration is set to the new target acceleration.

In Step S25, the server apparatus 200 transmits the new target acceleration set in Step S24 described above to the autonomous traveling vehicle 100. Accordingly, the vibration suppression control unit 1034 of the autonomous traveling vehicle 100 can execute the vibration attenuating process on the basis of the new target acceleration received from the server apparatus 200.

According to the embodiment described above, when the plurality of cargoes are transported by one autonomous traveling vehicle 100, it is also possible to realize the transport quality and the transport cost adequate for the respective cargoes.

Note that this embodiment describes the exemplary case in which the target acceleration is reset in real time when the change of the preferential cargo occurs in association with the loading/unloading of the cargo with respect to the autonomous traveling vehicle 100. However, the target acceleration for each of the routes to connect the respective cargo collection places may be set beforehand at the point in time at which the operation command is generated by the operation command generating unit 2022. In other words, the operation command may be generated so that the target acceleration is automatically changed at the point in time at which the autonomous traveling vehicle 100 arrives at the delivery place at which the prior preferential cargo is unloaded from the autonomous traveling vehicle 100 or the cargo collection place at which the new cargo having the required vibration suppression level higher than that of the preferential cargo having been already loaded is loaded on the autonomous traveling vehicle 100.

### Modified Embodiment of Second Embodiment

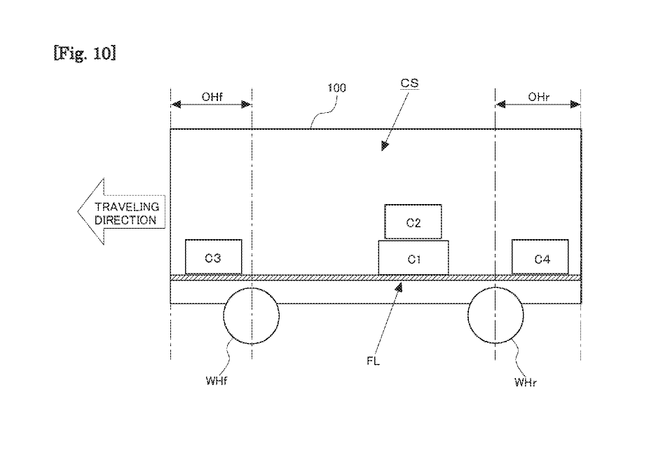

For example, the magnitude of the vibration generated in the cargo loading space of the autonomous traveling vehicle 100 is not necessarily uniform in the entire region of the space. FIG. 10 schematically indicates an example of the cargo loading space of the autonomous traveling vehicle 100. In the example shown in FIG. 10, the shaking width easily increases when the roll vibration and/or the pitch vibration is/are generated in relation to the cargo C2 which is stacked on another cargo, as compared with the cargo C1 which is directly arranged on the surface of the floor FL of the cargo loading space CS. Further, the shaking width easily increases when the heave vibration and/or the pitch vibration is/are generated in relation to the cargo C3 which is arranged on the overhang portion OHf disposed frontwardly from the axle of the front wheel WHf, of the surface of the floor FL and the cargo C4 which is arranged on the overhang portion OHr disposed backwardly from the axle of the rear wheel WHr, as compared with the cargo C1 which is arranged between the axel of the front wheel WHf and the axel of the rear wheel WHr. Therefore, it is affirmed that in the cargo loading space CS exemplarily shown in FIG. 10, the direct surface of the floor FL, which is disposed between the axel of the front wheel WHf and the axel of the rear wheel WHr, is the position (low vibration position) at which the vibration is relatively decreased, as compared with other positions (surface of any other cargo and the overhang portions OHf, OHr described above). Therefore, when the cargo is loaded on the autonomous traveling vehicle 100, it is desired that the cargo is arranged at the low vibration position as described above of the cargo loading space of the autonomous traveling vehicle 100. However, if the number of cargoes is increased, and/or if the sizes of cargoes are increased, then there is a possibility that it may be difficult to arrange all of the cargoes at the low vibration position as described above. In such a situation, there is a possibility that the cargo, which is arranged at the position (high vibration position) deviated from the low vibration position, may consequently receive the vibration larger than the assumed vibration.

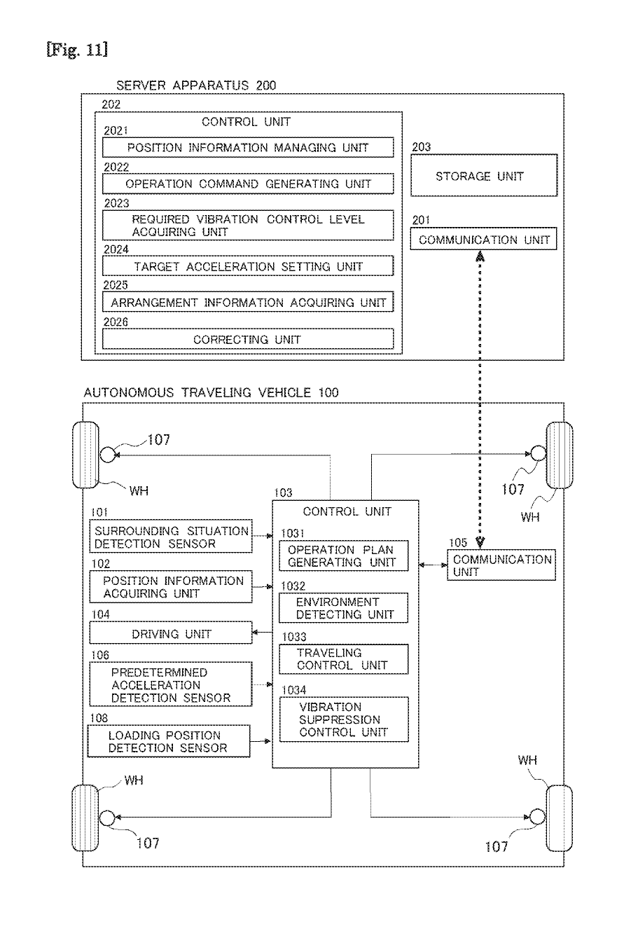

In view of the above, in this modified embodiment, the target acceleration is corrected so that the vibration suppression performance of the autonomous traveling vehicle 100 is further enhanced when the cargo is arranged at the high vibration position in the cargo loading space CS, as compared with when the cargo is not arranged at the high vibration position (when all cargoes are arranged at the low vibration position). In order to realize the method as described above, in this modified embodiment, the autonomous traveling vehicle 100 and the server apparatus 200 are configured as shown in FIG. 11. That is, the autonomous traveling vehicle 100 further comprises a loading position detection sensor 108 in addition to the constitutive components shown in FIG. 2 described above. The loading position detection sensor 108 is the sensor which detects the position (loading position) of the cargo loaded in the cargo loading space CS. As for the loading position detection sensor 108 as described above, it is possible to utilize, for example, a sensor which senses the loading position of the cargo by utilizing, for example, the infrared ray, the ultrasonic wave, or the visible light, or a camera which photographs the cargo loading space CS. The loading position information of the respective cargoes, which is detected by the loading position detection sensor 108, is transmitted to the server apparatus 200 via the communication unit 105.

On the other hand, the server apparatus 200 further comprises an arrangement information acquiring unit 2025 and a correcting unit 2026 as functional modules of the control unit 202 in addition to the functional modules shown in FIG. 2 described above. The arrangement information acquiring unit 2025 acquires the information in relation to the presence or absence the cargo at the high vibration position. Specifically, the arrangement information acquiring unit 2025 judges whether or not the cargo is arranged at the high vibration position on the basis of the loading position information received from the autonomous traveling vehicle 100. Accordingly, if it is judged that the cargo is arranged at the high vibration position, the information, which represents that the cargo is present at the high vibration position, is delivered from the arrangement information acquiring unit 2025 to the correcting unit 2026. On the other hand, if it is judged that the cargo is not arranged at the high vibration position, the information, which represents that the cargo is absent at the high vibration position, is delivered from the arrangement information acquiring unit 2025 to the correcting unit 2026.

If the information, which is delivered from the arrangement information acquiring unit 2025 to the correcting unit 2026, is the information which represents that the cargo is absent at the high vibration position, the correcting unit 2026 does not correct the target acceleration set by the target acceleration setting unit 2024 described above. On the other hand, if the information, which is delivered from the arrangement information acquiring unit 2025 to the correcting unit 2026, is the information which represents that the cargo is present at the high vibration position, the correcting unit 2026 corrects the target acceleration set by the target acceleration setting unit 2024 described above. Specifically, the correcting unit 2026 corrects the target acceleration set by the target acceleration setting unit 2024 in such a direction that the predetermined acceleration described above is suppressed to be smaller. The target acceleration, which is corrected as described above, is transmitted to the autonomous traveling vehicle 100 via the communication unit 201. Then, the vibration suppression control unit 1034 of the autonomous traveling vehicle 100 performs the vibration attenuating process in accordance with the target acceleration corrected by the correcting unit 2026. Accordingly, even when the cargo is arranged at the high vibration position of the cargo loading space CS, the quality of the cargo is secured.

### Other Embodiments

The autonomous traveling vehicle has been exemplified by way of example as the vehicle to which the present disclosure is applied in the respective embodiments and the modified embodiment described above. However, the present disclosure is also applicable to a vehicle which is driven by manual operation by a driver. Further, the example, in which the acquiring process for acquiring the required vibration suppression level and the setting process for setting the target acceleration are performed on the side of the server apparatus, has been described in the respective embodiments and the modified embodiment described above. However, these processes may be performed on the side of the vehicle.

Note that in the respective embodiments and the modified embodiment described above, the example has been described, in which the predetermined acceleration approaches the target acceleration by controlling one parameter (damping force characteristic (damping coefficient or attenuation coefficient) of the damper) of the plurality of parameters which affect the predetermined acceleration of the vehicle. However, there is no limitation thereto. The present disclosure is also applicable to such configuration that the predetermined acceleration approaches the target acceleration by controlling at least two parameters of the plurality of parameters which affect the predetermined acceleration of the vehicle.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A vehicle control apparatus applicable to a vehicle for transporting a cargo, the vehicle control apparatus comprising:
a controller comprising at least one processor,
the controller configured to:
acquire a required vibration suppression level which is a vibration suppression level required for the cargo transported by the vehicle;
set a target acceleration which is a target value of a predetermined acceleration including at least one of an acceleration in an upward-downward direction of the vehicle, an acceleration in a lateral direction of the vehicle, and an acceleration in a front-back direction of the vehicle when the cargo is transported by the vehicle, on the basis of the required vibration suppression level; and
adjust a parameter which affects the predetermined acceleration so that the predetermined acceleration approaches the target acceleration.

2. The vehicle control apparatus according to claim 1, wherein the controller sets the target acceleration so that the predetermined acceleration is suppressed to be smaller if the required vibration suppression level is high as compared with if the required vibration suppression level is low.

3. The vehicle control apparatus according to claim 1, wherein:
in a case where a plurality of cargoes are loaded on the vehicle;
the controller acquires the required vibration suppression levels for all of the cargoes loaded on the vehicle respectively; and
the controller sets the target acceleration on the basis of the highest required vibration suppression level of the required vibration suppression levels of all of the cargoes.

4. The vehicle control apparatus according to claim 2, wherein:
in a case where a plurality of cargoes are loaded on the vehicle;
the controller acquires the required vibration suppression levels for all of the cargoes loaded on the vehicle respectively; and
the controller sets the target acceleration on the basis of the highest required vibration suppression level of the required vibration suppression levels of all of the cargoes.

5. The vehicle control apparatus according to claim 3, wherein:
when the cargo, which has the highest required vibration suppression level of those of the cargoes loaded on the vehicle, is unloaded from the vehicle;
the controller newly sets the target acceleration on the basis of the highest required vibration suppression level of the required vibration suppression levels of all of the cargoes remaining on the vehicle.

6. The vehicle control apparatus according to claim 4, wherein:
when the cargo, which has the highest required vibration suppression level of those of the cargoes loaded on the vehicle, is unloaded from the vehicle;
the controller newly sets the target acceleration on the basis of the highest required vibration suppression level of the required vibration suppression levels of all of the cargoes remaining on the vehicle.

7. The vehicle control apparatus according to claim 3, wherein:
when a new cargo, which is distinct from the cargoes having been already loaded on the vehicle, is loaded on the vehicle;
the controller acquires a required vibration suppression level of the new cargo; and
the controller newly sets the target acceleration on the basis of the required vibration suppression level of the new cargo if the required vibration suppression level of the new cargo is higher than the required vibration suppression levels of all of the cargoes having been already loaded on the vehicle.

8. The vehicle control apparatus according to claim 4, wherein:
when a new cargo, which is distinct from the cargoes having been already loaded on the vehicle, is loaded on the vehicle;
the controller acquires a required vibration suppression level of the new cargo; and
the controller newly sets the target acceleration on the basis of the required vibration suppression level of the new cargo if the required vibration suppression level of the new cargo is higher than the required vibration suppression levels of all of the cargoes having been already loaded on the vehicle.

9. The vehicle control apparatus according to claim 5, wherein:
when a new cargo, which is distinct from the cargoes having been already loaded on the vehicle, is loaded on the vehicle;
the controller acquires a required vibration suppression level of the new cargo; and
the controller newly sets the target acceleration on the basis of the required vibration suppression level of the new cargo if the required vibration suppression level of the new cargo is higher than the required vibration suppression levels of all of the cargoes having been already loaded on the vehicle.

10. The vehicle control apparatus according to claim 6, wherein:
when a new cargo, which is distinct from the cargoes having been already loaded on the vehicle, is loaded on the vehicle;
the controller acquires a required vibration suppression level of the new cargo; and
the controller newly sets the target acceleration on the basis of the required vibration suppression level of the new cargo if the required vibration suppression level of the new cargo is higher than the required vibration suppression levels of all of the cargoes having been already loaded on the vehicle.

11. The vehicle control apparatus according to claim 3, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

12. The vehicle control apparatus according to claim 4, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

13. The vehicle control apparatus according to claim 5, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

14. The vehicle control apparatus according to claim 6, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

15. The vehicle control apparatus according to claim 7, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

16. The vehicle control apparatus according to claim 8, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

17. The vehicle control apparatus according to claim 9, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

18. The vehicle control apparatus according to claim 10, wherein the controller is further configured to:
acquire cargo arrangement information which is information about cargo arrangement in a cargo loading space of the vehicle; and
correct the target acceleration on the basis of the cargo arrangement information, wherein:
the controller adjusts the parameter which affects the predetermined acceleration on the basis of the corrected target acceleration.

19. A vehicle control system comprising:
a vibration control apparatus which is carried on a vehicle for transporting a cargo and which attenuates vibration of the vehicle by adjusting a parameter that affects a predetermined acceleration so that the predetermined acceleration, which includes at least one of an acceleration in an upward-downward direction of the vehicle, an acceleration in a lateral direction of the vehicle, and an acceleration in a front-back direction of the vehicle when the cargo is transported by the vehicle, approaches a target acceleration; and
a server apparatus which is an apparatus installed outside the vehicle, which sets the target acceleration, and which transmits the set target acceleration to the vibration control apparatus, the server apparatus comprising:
a controller comprising at least one processor,
the controller configured to:
acquire required vibration suppression levels which are vibration suppression levels required for respective cargoes in relation to all of the cargoes transported by the vehicle respectively;
set the target acceleration on the basis of the highest required vibration suppression level of the required vibration suppression levels of all of the cargoes; and
transmit the target acceleration to the vibration control apparatus.

20. The vehicle control system according to claim 19, wherein:
the vehicle further comprises an operation control apparatus which allows the vehicle to perform autonomous traveling in accordance with a predetermined operation command; and
the controller of the server apparatus generates the operation command on the basis of a cargo collection place and a delivery place of the cargo to be loaded on the vehicle to transmit the generated operation command to the operation control apparatus.
